(19) United States
(12) Patent Application Publication
(10) Pub. No.: US 2006/0272784 A1
(43) Pub. Date: Dec. 7, 2006

(54) Reinforced garage door

(76) Inventor: Ronald Huneycutt, Gastonia, NC (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/382,783

(22) Filed: May 11, 2006

Related U.S. Application Data
(60) Provisional application No. 60/594,853, filed on May 12, 2005.

(51) Int. Cl. E05D 15/00

(52) U.S. Cl. 160/201

(57) ABSTRACT

A reinforced garage door includes one or more panels moveable between an open position and a closed position. Reinforcing members are disposed within the panels to strengthen the door. Upper and lower anchor assemblies support the top and bottom of the door, respectively, in the closed position, to prevent inward or outward motion thereof. The normal operation of the door is not changed by the upper or lower anchor assemblies.

### TECHNICAL FIELD AND BACKGROUND OF THE INVENTION

This application claims the benefit of Provisional Application No. 60/594,853 filed on May 12, 2005.

The present invention relates to overhead garage doors. In particular, the invention relates to a reinforced overhead garage door capable of withstanding high wind conditions.

Overhead garage doors are used typically in the construction of residential dwellings and are usually made of a plurality of door sections which are hinged together and supported from a track system with rollers attached at opposite ends of the door sections. The garage doors come in various sizes, typically between 8 and 16 feet, and are made of various materials such as wood, painted galvanized steel, and fiberglass. Garage doors are susceptible to high winds due to their large exterior surface area and insufficient rigidity. Thus, very high winds acting upon the exterior surface of the garage door may cause the garage door to buckle, resulting in permanent deformation and, at the extreme, failure. Additionally, hurricanes and tornadoes can generate a very low pressure condition, resulting in a substantially lower pressure on the exterior of the door than on the interior of the door. This can also lead to buckling or failure.

Several reinforcement solutions have been proposed in the prior art to protect a garage door from high wind conditions. For example, one solution is to use a reinforcing strut which extends the width of and is attached to the inside surface of the door. The reinforcing strut enhances the rigidity of the door, but can be aesthetically unpleasant, and is only as strong as the fasteners used to attach the strut to the garage door. Thus, if the fasteners disengage from the garage door, the strut can no longer provide support to the door. Additionally, the reinforcing strut does not allow the garage door to be anchored to the garage opening.

Another solution is to use stiffening columns for reinforcing the entire vertical extent of a garage door. The stiffening columns are installed between associated upper mounting brackets above the garage opening and lower mounting brackets attached to the garage floor. The stiffening columns prevent the door from disengaging the door tracks, but can be aesthetically unpleasant and, when in use, prevent the garage door from being opened.

The present invention overcomes the disadvantages of prior art reinforced garage doors and addresses the problems associated with high wind conditions by providing a reinforced overhead garage door that is operable, visually unobtrusive, provides inward and outward buckling resistance, and can be anchored to a door opening.

### SUMMARY OF THE INVENTION

Therefore, it is an object of the invention to provide a reinforced overhead garage door that can be made of wood, steel, or fiberglass.

It is another object of the invention to provide a reinforced overhead garage door that includes a reinforcement member positioned between an inner exterior surface and an outer exterior surface of the garage door.

It is another object of the invention to provide a reinforced overhead garage door that includes an upper anchor assembly for anchoring the top of the garage door to a door opening.

It is another object of the invention to provide a reinforced overhead garage door that includes a lower anchor assembly for anchoring the bottom of the garage door to a door opening.

These and other objects of the present invention are achieved in the preferred embodiments disclosed below by providing a garage door section. The garage door section includes a first panel having an outer surface, an opposing inner surface, and a first open slot formed in the inner surface; and a second panel having an inner surface, an opposing outer surface, and a second open slot formed in the inner surface. The first and second panels are secured with their inner surfaces adjacent each other such that the first and second open slots are aligned to collectively form an enclosed slot. A reinforcing member is positioned in the enclosed slot and sandwiched between the first and second panels to provide resistance to bending.

According to another preferred embodiment of the invention, the first open slot extends substantially the length of the first panel.

According to another preferred embodiment of the invention, the second open slot extends substantially the length of the second panel.

According to another preferred embodiment of the invention, the cross-section of the reinforcing member is complimentary to the cross-section of the enclosed slot to prevent the reinforcing member from moving within the enclosed slot.

According to another preferred embodiment of the invention, the reinforcing member is elongated and extends substantially the length of the door section.

According to another preferred embodiment of the invention, further including a top rail positioned on an upper edge of the door section.

According to another preferred embodiment of the invention, the top rail defines a tongue portion of a tongue and groove.

According to another preferred embodiment of the invention, further including a bottom rail positioned on a lower edge of the door section.

According to another preferred embodiment of the invention, the bottom rail defines a groove portion of a tongue and groove.

According to another preferred embodiment of the invention, a garage door includes a plurality of door sections and a plurality of hinges interconnecting the door sections to form the garage door. Each of the door sections includes a first panel having an outer surface, an opposing inner surface, and a first open slot formed in the inner surface; and a second panel having an inner surface, an opposing outer surface, and a second open slot formed in the inner surface. The first and second panels being secured with their inner surfaces adjacent each other such that the first and second open slots are aligned to collectively form an enclosed slot. A reinforcing member is positioned in the enclosed slot and sandwiched between the first and second panels to provide resistance to bending.

According to another preferred embodiment of the invention, each of the door sections further include a top rail positioned on an upper edge of the door section and a bottom rail positioned on a lower edge of the door section.

According to another preferred embodiment of the invention, the top rail defines a tongue portion and the bottom rail defines a mating groove portion to allow adjacent door sections to stack one on top of the other.

According to another preferred embodiment of the invention, further including an upper anchor assembly having first and second segments, wherein the first segment is secured to a header of a garage door opening and the second segment is secured to a top edge of the garage door, the first and second segments adapted to engage each other when the garage door is in a closed position.

According to another preferred embodiment of the invention, the first segment includes a plurality of apertures and the second segment includes a plurality of complementary projections, wherein in the closed position the projections engage the apertures to prevent the top of the garage door from moving inwardly and outwardly.

According to another preferred embodiment of the invention, when the garage door is moved from a closed position to an open position, the projections disengage to the apertures to allow the garage door to move to the open position.

According to another preferred embodiment of the invention, further including a lower anchor assembly to secure a bottom of the garage door to a floor and prevent the bottom of the garage door from moving inwardly and outwardly.

According to another preferred embodiment of the invention, the lower anchor assembly includes an outer shaft for being inserted into a bottom of the garage door, an inner shaft positioned within the outer shaft, a biasing means for biasing the inner shaft towards a securing position, and a receiver disposed in the floor for receiving a portion of the inner shaft.

According to another preferred embodiment of the invention, a garage door assembly includes a door having spaced-apart top and bottom edges and spaced-apart side edges for being mounted in an opening of a wall defined by a header, spaced-apart sidewalls, and a floor; an upper anchor assembly; and a lower anchor assembly. The upper anchor assembly includes a first segment secured to the header of the opening; and a second segment secured to the top edge of the door for mating engagement with the first segment when the door is in a closed position. The lower anchor assembly includes an outer shaft for being positioned in the bottom edge of the door; an inner shaft positioned within the outer shaft; a biasing means positioned within the outer shaft for biasing the inner shaft towards a securing position; and a receiver disposed in the floor for receiving a portion of the inner shaft. The upper and lower anchor assemblies prevent the top and bottom edges of the door from moving inwardly and outwardly.

According to another preferred embodiment of the invention, further including spaced-apart tracks attached to the sidewalls and cooperating with the side edges of the door for allowing the door to be moved between a generally vertical closed position and a generally horizontal open position.

According to another preferred embodiment of the invention, the door includes a plurality of door sections interconnected in a stacked relation by a plurality of hinges.

According to another preferred embodiment of the invention, each of the door sections include a reinforcing member sandwiched between a first panel and a second panel to provide resistance to bending.

According to another preferred embodiment of the invention, the reinforcing member extends the length of the door section.

According to another preferred embodiment of the invention, the first segment includes a plurality of apertures and the second segment includes a plurality of complementary projections, wherein in the closed position the projections engage the apertures.

According to another preferred embodiment of the invention, when the garage door is moved from a closed position to an open position, the projections disengage to the apertures to allow the door to move to the open position.

### BRIEF DESCRIPTION OF THE FIGURES

Some of the objects of the invention have been set forth above. Other objects and advantages of the invention will appear as the invention proceeds when taken in conjunction with the following drawings, in which:

FIG. 1 shows a garage with an overhead garage door according to an embodiment of the invention;

FIG. 2 shows a rear view of the overhead garage door of FIG. 1;

FIG. 3 shows a partially cut-away front view of a garage door panel of the garage door of FIG. 1;

FIG. 4 is a side cross-section of the door panel of FIG. 3;

FIG. 5 shows an upper anchor assembly attached to a top of the garage door of FIG. 1;

FIG. 6 shows a side cross-section of the upper anchor assembly of FIG. 5;

FIG. 7 shows a lower anchor assembly installed in a bottom of the garage door of FIG. 1; and

FIG. 8 is a side cross-section of the lower anchor assembly of FIG. 7.

### DESCRIPTION OF THE PREFERRED EMBODIMENT AND BEST MODE

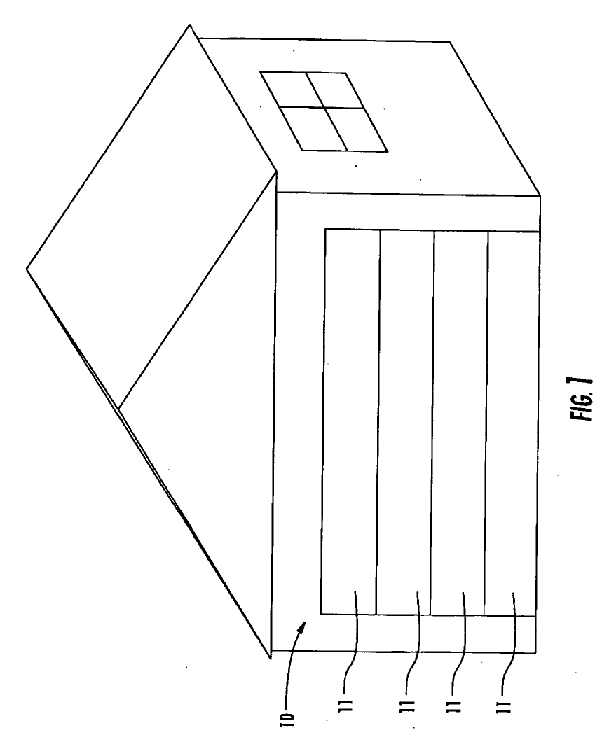

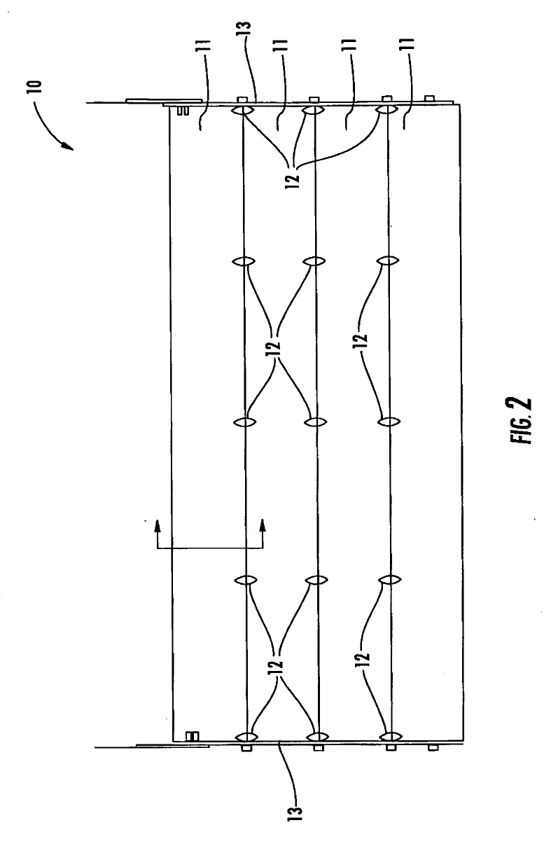

Referring now specifically to the drawings, an overhead garage door according to an embodiment of the invention is illustrated in FIGS. 1 and 2 and shown generally at reference numeral 10. As illustrated, the garage door 10 is a sectional garage door, however, the invention is not limited to sectional garage doors and may be used with one piece garage doors, as well.

The garage door 10 includes a plurality of door panels 11 and a plurality of hinges 12 for interconnecting the panels 11. Tracks 13 are positioned on opposing side edges of the garage door 10 for allowing the garage door 10 to move from a vertical closed position to a horizontal open position. The garage door 10 may be made of various materials such as wood, steel, and fiberglass.

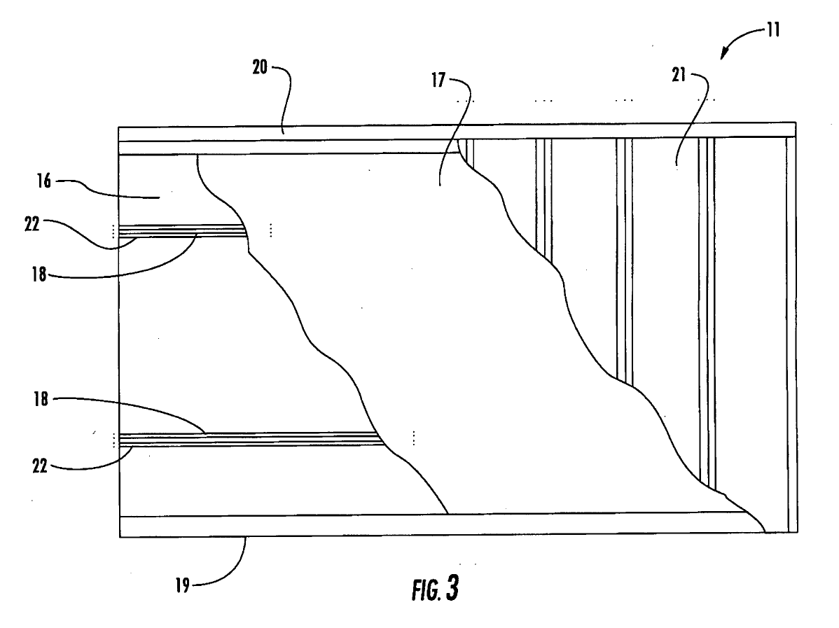

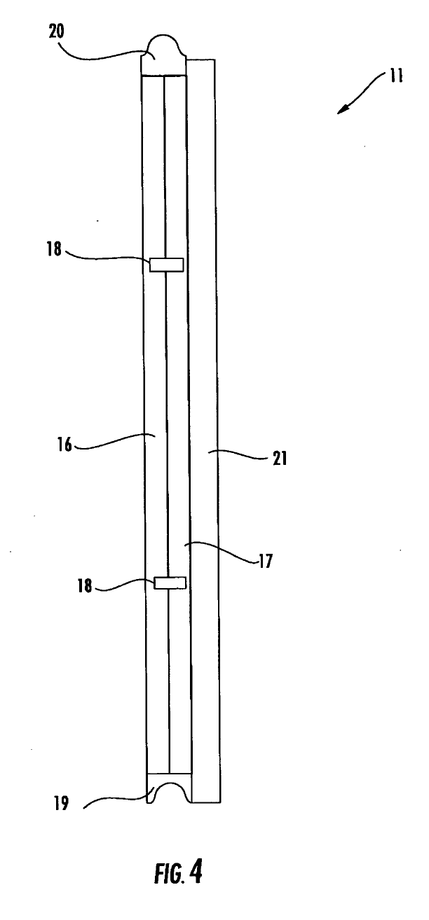

Referring to FIGS. 3 and 4, the door panels 11 include a back panel 16, an inner panel 17, a plurality of reinforcement members 18 sandwiched between the inner panel 17 and the back panel 16, as shown in FIG. 4, a bottom rail 19, a top rail 20, and a decorative face panel 21. The bottom rail 19 and top rail 20 are cut to form tongue and groove mating surfaces to allow adjacent door panels 11 to stack one on top of another. As shown, the top rail 20 forms the tongue section and the bottom rail 19 forms the groove section.

Each of the reinforcing members 18 is placed into a respective slot 22 formed in both the inner panel 17 and back panel 16 and extends laterally from one side edge to the other to prevent the door panel 11 from buckling both inwardly and outwardly. The slot 22 has a cross-sectional dimension and shape complementary to the reinforcing members 18, thereby securing the reinforcing members 18 from within the door panel 11. The reinforcing members 18 may be of various cross-sectional shapes such as rectangular and circular, and may be made of any suitable material, such as steel, which provides adequate rigidity. By incorporating the reinforcing members 18 into the construction of the panels 11, a stronger door 10 may be manufactured since the strength of the reinforcing member 18 is not limited by fasteners used to attach a strut or other reinforcement to the surface of a door.

As shown in FIG. 3, two reinforcing members 18 are positioned in a spaced-apart relation to enhance the rigidity of the door panel 11. Additional reinforcing members may be added to the panels 11, if needed.

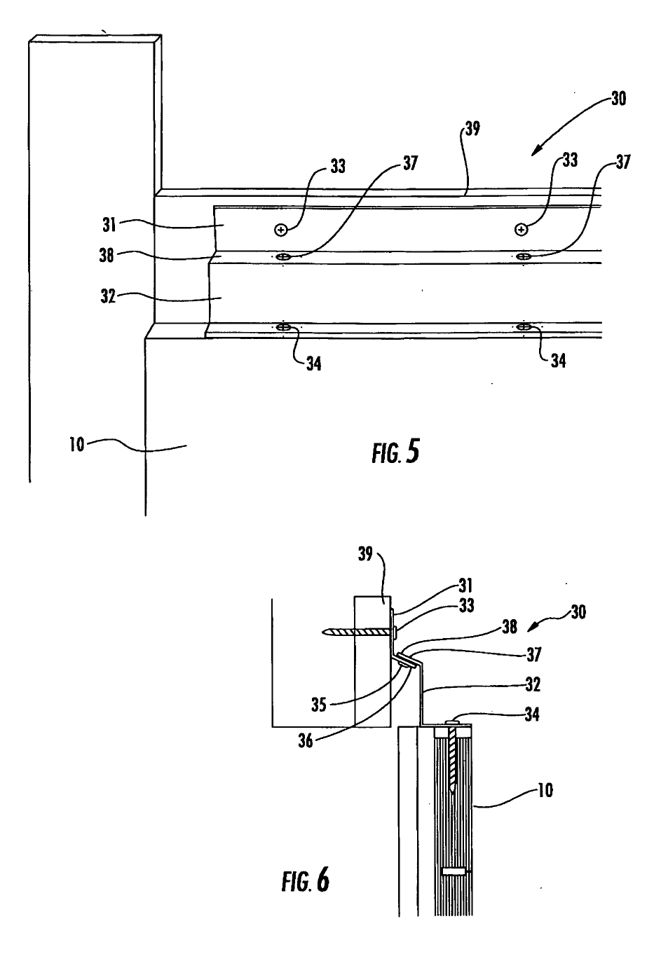

Referring to FIGS. 5 and 6, an upper anchor assembly 30 may be used to secure the top of the garage door 10 to a header 39 of the door opening. The upper anchor assembly 30 has a first segment 31 and a second segment 32. As shown, the first and second segments 31 and 32 are made of steel angle, but other suitable materials may also be used. The first segment 31 is attached to the header 39 by a plurality of fasteners 33. The second segment 32 is attached to a top edge of the garage door 10 by a plurality of fasteners 34. The first segment 31 includes a plurality of apertures 35 positioned along a free end 36 of the first segment 31 in a spaced-apart fashion. The second segment 32 includes a plurality of complementary projections 37 positioned along a free end 38 of the second segment 32 and spaced to align with the apertures 35. When the garage door 10 is in the vertical closed-position, the projections 37 engage the apertures 35 preventing the top of the garage door 10 from moving inwardly and outwardly.

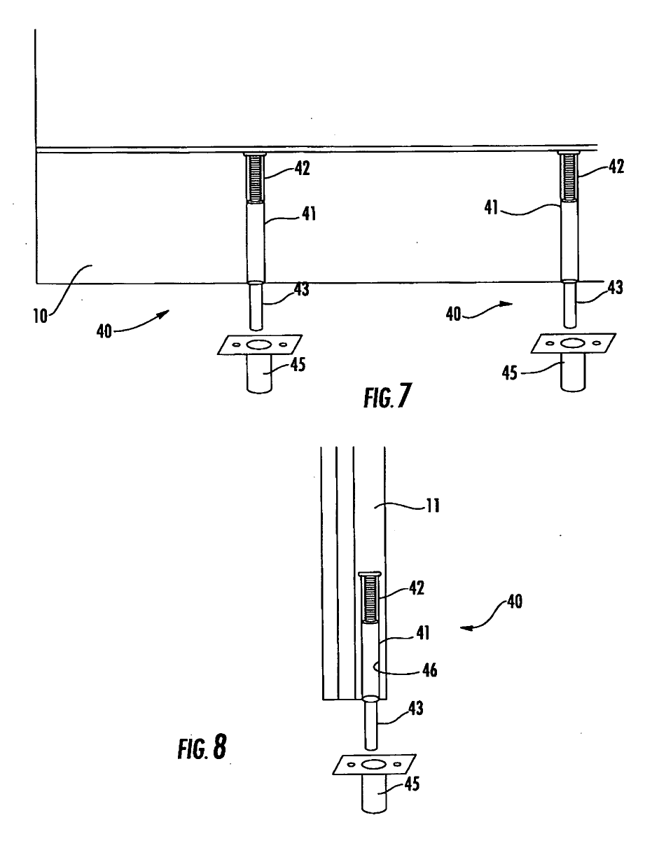

As shown in FIGS. 7 and 8, a plurality of lower anchor assemblies 40 may be used to secure the bottom of the garage door 10 to the garage floor, thereby preventing the bottom of the garage door 10 from moving in the inwardly and outwardly direction. Each of the lower anchor assemblies 40 includes an outer shaft 41, a spring 42, an inner shaft 43, and a receiver 45. The outer shaft 41 is inserted into a recess 46 formed in the bottom door section 11 and houses the spring 42 and inner shaft 43. The receiver 45 is embedded in the garage floor in alignment with the inner shaft 43 for receiving the inner shaft 43 therein. The spring 42 forces the inner shaft 43 to extend past the bottom edge of the garage door 10 and into engagement with the receiver 45. The spring 42 also allows the inner shaft 43 to move upwardly into the outer shaft 41 when under a load to prevent the inner shaft 43 from injuring a child or from preventing the garage door 10 from closing completely in the event the inner shaft 43 does not align with the receiver 45.

Referring to FIGS. 5-8, the upper anchor assembly 30 and lower anchor assemblies 40 are designed to permit the garage door 10 to operate in a normal manner without any interaction by a user. When the garage door 10 is moved from a vertical closed position to a horizontal open position, the projections 37 disengage the apertures 35 and the inner shaft 43 disengages the receiver 45 to allow the garage door 10 to open in a normal manner. When the garage door 10 is moved from the horizontal open position to the vertical closed position, the projections 37 engage the apertures 35 and the inner shaft 43 engages the receiver 45. Thus, it can be seen that the garage door 10 can be secured in a closed position to resist high wind conditions without affecting the normal operation of the garage door 10.

A garage door is described above. Various details of the invention may be changed without departing from its scope. Furthermore, the foregoing description of the preferred embodiments of the invention and the best mode for practicing the invention are provided for the purpose of illustration only and not for the purpose of limitation.

I claim:

1. A garage door section, comprising:
(a) a first panel having an outer surface, an opposing inner surface, and a first open slot formed in the inner surface;
(b) a second panel having an inner surface, an opposing outer surface, and a second open slot formed in the inner surface;
(c) the first and second panels being secured with their inner surfaces adjacent each other, such that the first and second open slots are aligned to collectively form an enclosed slot; and
(d) a reinforcing member positioned in the enclosed slot and sandwiched between the first and second panels to provide resistance to bending.

2. The garage door section according to claim 1, wherein the first open slot extends substantially the length of the first panel.

3. The garage door section according to claim 1, wherein the second open slot extends substantially the length of the second panel.

4. The garage door section according to claim 1, wherein the cross-section of the reinforcing member is complimentary to the cross-section of the enclosed slot to prevent the reinforcing member from moving within the enclosed slot.

5. The garage door section according to claim 1, wherein the reinforcing member is elongated and extends substantially the length of the door section.

6. The garage door section according to claim 1, and further including a top rail positioned on an upper edge of the door section.

7. The garage door section according to claim 6, wherein the top rail defines a tongue portion of a tongue and groove.

8. The garage door section according to claim 1, and further including a bottom rail positioned on a lower edge of the door section.

9. The garage door section according to claim 8, wherein the bottom rail defines a groove portion of a tongue and groove.

10. A garage door, comprising:
(a) a plurality of door sections, each of the door sections comprising:
(i) a first panel having an outer surface, an opposing inner surface, and a first open slot formed in the inner surface;
(ii) a second panel having an inner surface, an opposing outer surface, and a second open slot formed in the inner surface;
(iii) the first and second panels being secured with their inner surfaces adjacent each other, such that the first and second open slots are aligned to collectively form an enclosed slot;
(iv) a reinforcing member positioned in the enclosed slot and sandwiched between the first and second panels to provide resistance to bending; and
(b) a plurality of hinges for interconnecting the door sections to form the garage door.

11. The garage door according to claim 10, wherein each of the door sections further include a top rail positioned on an upper-edge of the door section and a bottom rail positioned on a lower edge of the door section.

12. The garage door according to claim 11, wherein the top rail defines a tongue portion and the bottom rail defines a mating groove portion to allow adjacent door sections to stack one on top of the other.

13. The garage door according to claim 10, and further including an upper anchor assembly having first and second segments, wherein the first segment is secured to a header of a garage door opening and the second segment is secured to a top edge of the garage door, the first and second segments adapted to engage each other when the garage door is in a closed position.

14. The garage door according to claim 13, wherein the first segment includes a plurality of apertures and the second segment includes a plurality of complementary projections, wherein in the closed position the projections engage the apertures to prevent the top of the garage door from moving inwardly and outwardly.

15. The garage door according to claim 14, wherein when the garage door is moved from a closed position to an open position, the projections disengage to the apertures to allow the garage door to move to the open position.

16. The garage door according to claim 10, and further including a lower anchor assembly to secure a bottom of the garage door to a floor and prevent the bottom of the garage door from moving inwardly and outwardly.

17. The garage door according to claim 16, wherein the lower anchor assembly includes an outer shaft for being inserted into a bottom of the garage door, an inner shaft positioned within the outer shaft, a biasing means for biasing the inner shaft towards a securing position, and a receiver disposed in the floor for receiving a portion of the inner shaft.

18. A garage door assembly, comprising:
(a) a door having spaced-apart top and bottom edges and spaced-apart side edges for being mounted in an opening of a wall defined by a header, spaced-apart sidewalls, and a floor;
(b) an upper anchor assembly, comprising:
(i) a first segment secured to the header of the opening; and
(ii) a second segment secured to the top edge of the door for mating engagement with the first segment when the door is in a closed position;
(c) a lower anchor assembly, comprising:
(i) an outer shaft for being positioned in the bottom edge of the door;
(ii) an inner shaft positioned within the outer shaft;
(iii) a biasing means positioned within the outer shaft for biasing the inner shaft towards a securing position;
(iv) a receiver disposed in the floor for receiving a portion of the inner shaft; and
(d) wherein the upper and lower anchor assemblies prevent the top and bottom edges of the door from moving inwardly and outwardly.

19. The garage door assembly according to claim 18, and further including spaced-apart tracks attached to the sidewalls and cooperating with the side edges of the door for allowing the door to be moved between a generally vertical closed position and a generally horizontal open position.

20. The garage door assembly according to claim 18, wherein the door includes a plurality of door sections interconnected in a stacked relation by a plurality of hinges.

21. The garage door according to claim 20, wherein each of the door sections include a reinforcing member sandwiched between a first panel and a second panel to provide resistance to bending.

22. The garage door according to claim 21, wherein the reinforcing member extends the length of the door section.

23. The garage door assembly according to claim 18, wherein the first segment includes a plurality of apertures and the second segment includes a plurality of complementary projections, wherein in the closed position the projections engage the apertures.

24. The garage door according to claim 23, wherein when the garage door is moved from a closed position to an open position, the projections disengage to the apertures to allow the door to move to the open position.
